(19) United States
(12) Patent Application Publication
(10) Pub. No.: US 2026/0177477 A1
(43) Pub. Date: Jun. 25, 2026

(54) DOUBLE-PASS SPECTROMETER USING A FLAT REFLECTIVE DIFFRACTION GRATING AND MULTI-ELEMENT LENSES

(71) Applicant: HORIBA Instruments Incorporated, Irvine, CA (US)

(72) Inventors: Feng Zhao, West Windsor, NJ (US); Aashish Tuladhar, Hillsborough, NJ (US); Chris George, Leonardo, NJ (US); Jeremy Goldstone, Hillsborough, NJ (US); Nicolas Vezard, Edison, NJ (US)

(21) Appl. No.: 19/423,327

(22) Filed: Dec. 17, 2025

Related U.S. Application Data
(60) Provisional application No. 63/736,452, filed on Dec. 19, 2024.

(51) Int. Cl. G01N 21/31

(52) U.S. Cl. CPC G01N 21/31; G01N 2201/0635

(57) ABSTRACT

A spectrometer includes an entrance aperture, a lens system that receives and collimates light, a flat reflective diffraction grating that diffracts and reflects the light back through the lens system, and a sensor that detects the returned light. The lens system collimates the light during a first pass and focuses it onto the sensor during a second pass. Various embodiments include selectable entrance apertures, imaging optics, different grating geometries and groove densities, and configurations supporting telecentric performance or multi-channel spectral acquisition.

### CROSS-REFERENCE TO RELATED APPLICATION

This application claims the benefit of U.S. provisional application Ser. No. 63/736,452, filed Dec. 19, 2024, the disclosure of which is hereby incorporated in its entirety by reference herein.

### TECHNICAL FIELD

This technology relates to optical spectroscopy systems that disperse and analyze light based on wavelength. More specifically, it concerns double-pass spectrometers that use flat reflective diffraction gratings and multi-element lens assemblies to achieve high-resolution spectral detection for applications such as Raman spectroscopy and optical emission spectroscopy.

### BACKGROUND

Spectroscopic instruments are widely used to separate and measure the wavelength components of light for scientific, industrial, and analytical applications. These instruments typically use optical elements such as lenses, mirrors, and diffraction gratings to disperse incident light and to generate a wavelength-resolved output for analysis.

### SUMMARY

The present disclosure relates to spectrometers configured to disperse and analyze light using compact optical architectures suitable for high-resolution spectral detection. In various embodiments, a spectrometer may include an entrance aperture that directs light toward a lens system, a flat reflective diffraction grating arranged to receive collimated light from the lens system and to diffract and reflect the light, and a sensor positioned to detect the diffracted light after it passes back through the lens system. The lens system may be arranged to collimate the light during a first pass toward the diffraction grating and to focus the light onto the sensor during a second pass, thereby providing a double-pass optical configuration.

The lens system may include an assembly of multiple optical elements, which may incorporate refractive components, diffractive components, metasurface elements, or combinations thereof. The entrance aperture may be implemented as a slit, a slit array, a single optical fiber, a fiber array, or other equivalent structures. Certain embodiments provide a plurality of individually selectable entrance apertures arranged in a vertical or horizontal array to support single-channel or multi-channel operation. In multi-channel operation, spectra from different entrance apertures may be recorded simultaneously on the sensor, and the corresponding spectral traces may be spatially displaced to avoid overlap.

Imaging optics may be provided to form an image of an elongated optical source along the entrance aperture. The entrance aperture and the sensor may be located in the same plane or in different planes, and in some arrangements an entrance port and an exit port may be positioned at respective object and image planes of the lens system. The object and image planes may share the same orientation or may differ in orientation to accommodate rotated or orthogonal geometries. The entrance and exit ports may be positioned at the same or at different working distances from the lens system depending on system requirements.

The diffraction grating may be implemented as a flat reflective optical dispersing element, such as a ruled grating, holographic grating, or metasurface grating. The grating may include parallel or non-parallel grooves, equal or non-equal groove spacing, or curved or non-curved groove profiles. In certain embodiments, the diffraction grating has a groove density greater than 350 grooves per millimeter, or greater than 900 grooves per millimeter for higher-resolution applications.

Some spectrometers according to the present disclosure may be configured so that chief rays associated with different wavelengths impinge on the sensor at the same angle, which may promote telecentric or near-telecentric performance. In addition, light entering the spectrometer may pass through the lens system toward the diffraction grating and return through the lens system toward the sensor, thereby establishing a compact double-pass optical configuration. The disclosed spectrometers may be used in a variety of spectrometric techniques, including optical emission spectroscopy, optical reflectometry, optical coherence tomography, and spectral-domain optical coherence tomography.

### BRIEF DESCRIPTION OF THE DRAWINGS

FIGS. 1 and 2 are schematic diagrams illustrating double-pass optical systems for spectroscopy that incorporates a flat substrate reflection diffraction grating having a groove density greater than 350 grooves per millimeter.

FIG. 3 is a ray-tracing simulation illustrating a representative lens system or lens assembly used in a double-pass optical system for spectroscopy.

### DETAILED DESCRIPTION

Detailed embodiments of the present disclosure are described herein. However, these embodiments are provided by way of example only, and the disclosure may take various other forms. The figures are not necessarily drawn to scale, and certain features may be exaggerated or reduced to highlight specific components. Accordingly, the structural and functional details set forth herein are not intended to limit the scope of the disclosure, but rather to provide a representative description that enables those skilled in the art to practice the disclosed subject matter in a variety of ways.

A spectrometer separates incoming radiation into its constituent wavelengths and enables spectroscopic analysis to identify and characterize sample properties such as chemical composition. Raman spectrometers are a specific type of optical grating spectrometer designed to detect weak inelastic scattering signals generated when an excitation laser interacts with molecular vibrational or rotational modes in a sample. Because the Raman effect produces wavelength shifts that are typically only a few tens to several thousand inverse centimeters from the excitation wavelength, Raman systems require high spectral resolution and low stray-light backgrounds to reliably isolate these weak features. The accessible spectral range of a Raman spectrometer is determined primarily by the wavelength of the excitation laser and by the dispersion characteristics of the optical grating.

Modern Raman spectrometers incorporate additional subsystems that support accurate signal acquisition, including narrowband laser sources with low linewidth, optical filters such as edge or notch filters that suppress Rayleigh scatter, and well-corrected imaging optics that couple light efficiently into the spectrometer. Grating selection, groove density, and blaze wavelength are chosen to optimize efficiency and dispersion for the specific excitation wavelength. Detector technologies, such as Charge-Coupled Devices (CCDs) or scientific Complementary Metal-Oxide-Semiconductor (CMOS) sensors, should offer high sensitivity, low dark current, and low readout noise because Raman scattering is inherently weak.

Beyond these subsystem-level considerations, spectrometer architectures themselves have evolved over time, beginning with single concave-grating Rowland circle designs and progressing to traditional Czerny-Turner systems that use reflective mirrors or transmissive lenses, as well as Ebert-Fastie, Dyson, Offner, and transmission-grating systems. These architectures manage optical aberrations, stray light, and throughput in different ways. For example, Czerny-Turner systems allow flexible focal lengths and grating sizes but can suffer from astigmatism and scattered light unless carefully corrected. Dyson and Offner designs provide imaging quality and reduced aberrations but may impose stricter constraints on component geometry. Transmission-grating spectrometers can offer compact form factors and high efficiency but may have limited wavelength coverage depending on grating design.

In contrast to Raman-optimized spectrometer architectures, some optical systems disclose wavelength-division multiplexing and demultiplexing configurations that incorporate a double-pass lens or lens assembly and a flat diffraction grating that operates in a diffraction order greater than one. Such systems often use an Echelle grating, which has a groove spacing greater than or equal to approximately three times the wavelength of the incident light. The grating may be arranged in a Littrow configuration, in which the angle of incidence equals the angle of diffraction, in order to maximize diffraction efficiency at a specific wavelength or within a narrow wavelength band, for example within the 1300 nm to 1550 nm telecommunications window. An Echelle grating typically has a relatively low groove density, for example less than about 320 grooves per millimeter, and uses groove profiles optimized for high incidence angles and therefore for operation in high diffraction orders.

Although effective for optical signal transmission, these configurations are generally unsuitable for Raman spectroscopy or Optical Emission Spectroscopy (OES). Raman systems typically require diffraction gratings with significantly higher groove densities, for example greater than or equal to 900 grooves per millimeter, while OES systems may require groove densities greater than or equal to 350 grooves per millimeter. These instruments operate in the first diffraction order, use a well-defined entrance slit that may be implemented by a physical slit, a single optical fiber, a vertically aligned fiber array, or combinations of these elements, and should accommodate a substantially broader wavelength range, for example from 500 nm to 1075 nm for Raman spectroscopy or from 200 nm to 1100 nm for OES.

In view of the limitations associated with existing spectrometer architectures, including those used for Raman spectroscopy, the inventors undertook an extensive investigation into Dyson-based configurations. After months of optimization efforts, the inventors recognized that the high groove density gratings required to achieve Raman-level resolution are difficult or impractical to implement in systems that rely on concave gratings. Combining a concave substrate with high groove densities presents significant fabrication and optical-design challenges that restrict attainable resolution and efficiency. As a result, the inventors used advanced optical design and simulation tools, such as Zemax, to develop an optimized spectrometer lens system that uses flat reflection gratings while still achieving Raman-grade resolution, for example less than about 6 cm¹ across the full Raman spectral range. The resulting spectrometer design and methods contemplated herein address shortcomings of existing Raman spectrometers and provide a unique balance of performance characteristics while reducing the impact of design compromises. The disclosed systems may offer high throughput, high resolution, desirable functional capabilities, flexibility to accommodate various lasers and gratings, suitable working distance, compact form factor, thermal stability, or high reliability.

In one or more embodiments, a Raman spectrometer includes a double-pass lens or double-pass lens assembly, a flat substrate reflection diffraction grating, and a linear or planar sensor array. Light entering the spectrometer through an entrance slit or aperture, or delivered by an optical fiber or fiber array, passes through the lens assembly and is directed onto the reflection grating. The grating diffracts the light back through the same lens assembly, and the dispersed wavelengths are focused onto different locations of the sensor based on their wavelength or frequency. Suitable sensors include CCDs, scientific CMOS arrays, or Indium Gallium Arsenide (InGaAs) detectors, each having a plurality of pixels that measure and record the spectrally dispersed light. This double-pass configuration allows both the input and diffracted light to utilize the same optical elements, which supports compact system dimensions and high optical performance. Embodiments may also include supplemental side-entrance optics or side-exit optics that incorporate one or more additional optical elements as needed.

Certain systems and methods according to the present disclosure offer several advantages over traditional spectrometer designs. For example, the use of a flat diffraction grating enables greater flexibility in selecting commercially available gratings with appropriate groove frequencies, wavelength coverage, blaze angles, and efficiency characteristics that meet specific performance requirements for Raman or other spectrometry applications. This flexibility stands in contrast to systems that rely on concave or convex gratings, which often require custom-designed master gratings that increase development time and cost and limit design adaptability.

Various embodiments also provide high throughput while maintaining high spectral resolution, which is particularly valuable for demanding Raman applications. The lens assembly described herein supports fast optical collection and corrects aberrations more effectively than one-mirror or two-mirror Rowland-circle systems, traditional Czerny-Turner configurations, or even the three-mirror arrangements of Offner designs. A fast system collects more light, resulting in better throughput and sensitivity. Flat gratings also generally exhibit higher diffraction efficiency than curved gratings within comparable spectral and groove-density ranges. Furthermore, flat gratings facilitate uniform illumination by parallel input beams operating near the blaze condition, which facilitates high efficiency across the full illuminated grating area. Curved gratings in prior-art systems cannot achieve such uniformity due to varying local incidence angles across their surface.

The double-pass configuration of some embodiments substantially reduces overall spectrometer size compared to transmission-based flat grating arrangements because both the input light and the dispersed output share a common optical path region. Additionally, the entrance aperture and sensor array may be positioned at the focal plane of the lens assembly or in different planes, which allows significantly longer working distances than those attainable in Dyson-type spectrometers of comparable spectral resolution. The system can further be arranged to operate in a telecentric or near-telecentric condition, in which the location of the spectral chief ray on the sensor array remains substantially unchanged when the sensor is displaced from the focal plane. This characteristic improves spectral accuracy and stability during operation.

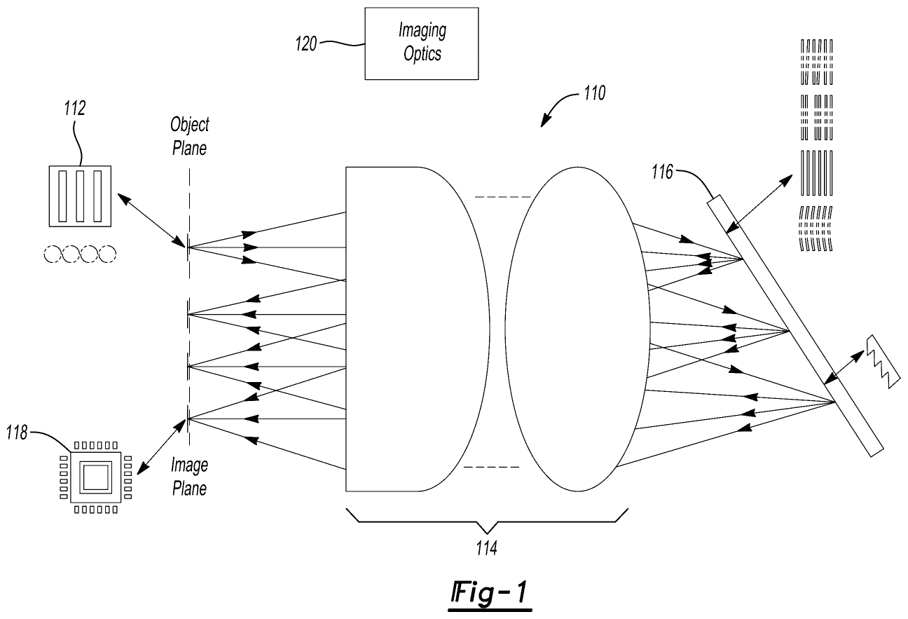

Referring to FIG. 1, a spectrometer 110 includes an entrance assembly 112, a lens assembly 114, a flat substrate reflection diffraction grating 116, a sensor array 118, and imaging optics 120. In some embodiments, the entrance assembly 112 provides one or more selectable entrance apertures arranged in a vertical or horizontal array. The entrance apertures may be implemented as mechanical slits, optical fibers, or fiber arrays. A switching mechanism or electronically controlled selection element may be used to select a single entrance channel for single-spectrum operation or multiple channels for multi-spectrum operation. Examples of selection elements include mechanically actuated slit plates, motorized fiber-positioning stages, rotary turrets, MEMS optical switches, digitally controlled micro-mirror arrays, or liquid-crystal shutters, although other selection mechanisms may be used. When multiple channels are selected, the lens assembly 114 and the diffraction grating 116 are configured to produce either vertically stacked spectra on the sensor array 118 corresponding to vertically displaced entrance positions, or laterally shifted spectra that prevent overlap across the width of the sensor array 118.

Light diffracted and reflected by the flat substrate reflection diffraction grating 116 is refocused by the lens assembly 114 onto the sensor array 118, which is located at an image plane of the lens assembly 114 in the embodiment of FIG. 1. The sensor array 118 may be implemented as a one-dimensional or two-dimensional detector array, such as a CCD, CMOS, or InGaAs device, and may be operated in cooled or uncooled configurations. A two-dimensional array may be used to record multiple spectra simultaneously, including vertically stacked spectra or laterally shifted spectra produced by different entrance channels. The sensor array 118 may provide electronic signals to a computing system configured to process or analyze the recorded spectra.

In some embodiments, the imaging optics 120 are positioned adjacent to the entrance assembly 112 and are configured to form a magnified, demagnified, or unit-magnification image of an elongated optical source, such as an optical fiber, a fiber line array, or a slit-illuminated sample region, along the entrance assembly 112. The imaging optics 120 may include refractive lenses, diffractive lenses, metasurface lenses, or combinations thereof. The imaging optics 120 map the spatial extent of the input source across the height or width of the entrance assembly 112. This mapping promotes spectral stability and provides correspondence between different entrance channels and the resulting spectra on the sensor array 118.

In some embodiments, the entrance aperture defines or is positioned at an entrance port located at the object plane of the lens assembly 114. The entrance assembly 112 and the sensor array 118 may be positioned in the same plane or in different planes depending on the desired optical configuration. In the arrangement illustrated in FIG. 1, the entrance assembly 112 lies in the object plane and the sensor array 118 lies in the image plane of the lens assembly 114. The object plane and the image plane may share the same orientation, such as both being vertical or both horizontal relative to the optical path, or they may differ in orientation so that the entrance port and exit port are rotated or orthogonal relative to one another. These geometric variations allow the entrance port and exit port to be located at the same working distance from the lens assembly 114 or at different working distances selected to meet compactness, telecentricity, or mechanical packaging requirements.

The lens assembly 114 may incorporate one or more refractive lenses, diffractive lenses, metasurface lenses, or combinations of such elements. Diffractive lenses and metasurface-based elements may be used to correct chromatic aberrations. They may also be used to flatten field curvature. They may further reduce overall system size and weight. These characteristics support compact implementations suitable for portable Raman or optical emission spectrometers. The lens assembly 114 may further include coatings selected to optimize performance for particular excitation wavelengths, such as 532 nm, 638 nm, 785 nm, 830 nm, or other wavelengths used in Raman spectroscopy, optical emission spectroscopy, reflectometry, or spectral-domain optical coherence tomography.

The diffraction grating 116 may be implemented as a flat reflective optical dispersing element. Examples include ruled gratings, holographic gratings, gratings with parallel or non-parallel grooves, gratings with equal or non-equal groove spacing, gratings with curved or non-curved groove profiles, or metasurface-based dispersive structures configured to introduce wavelength-dependent angular dispersion. The diffraction grating 116 may be mounted in a grating mount. In some embodiments, a single mechanical housing is used to hold interchangeable diffraction gratings 116 with different groove densities while using the same lens assembly 114. The lens assembly 114 may include different optical coatings for different laser wavelengths without altering the underlying optical geometry of the spectrometer 110.

The spectrometer 110 may be used in Raman spectroscopy, optical emission spectroscopy, optical reflectometry, optical coherence tomography, spectral-domain optical coherence tomography, and other spectrometric applications that require high throughput and high spectral resolution. For Raman spectroscopy, the spectrometer 110 may use a diffraction grating with a groove density greater than 900 grooves per millimeter. For optical emission spectroscopy, groove densities greater than 350 grooves per millimeter may be used. The double-pass geometry provides high resolution in a compact form factor and supports long working distances suitable for cooled or uncooled detectors, vacuum-mounted sensors, or deep-insertion optical assemblies.

In some embodiments, the spectrometer 110 is configured to operate in a telecentric or near-telecentric condition at the sensor array 118. Telecentric operation causes the chief ray associated with each wavelength to strike the corresponding detector pixel at substantially the same angle, even when the sensor array 118 is displaced from the focal plane. This behavior results in more stable wavelength calibration and reduced sensitivity to sensor positioning variations.

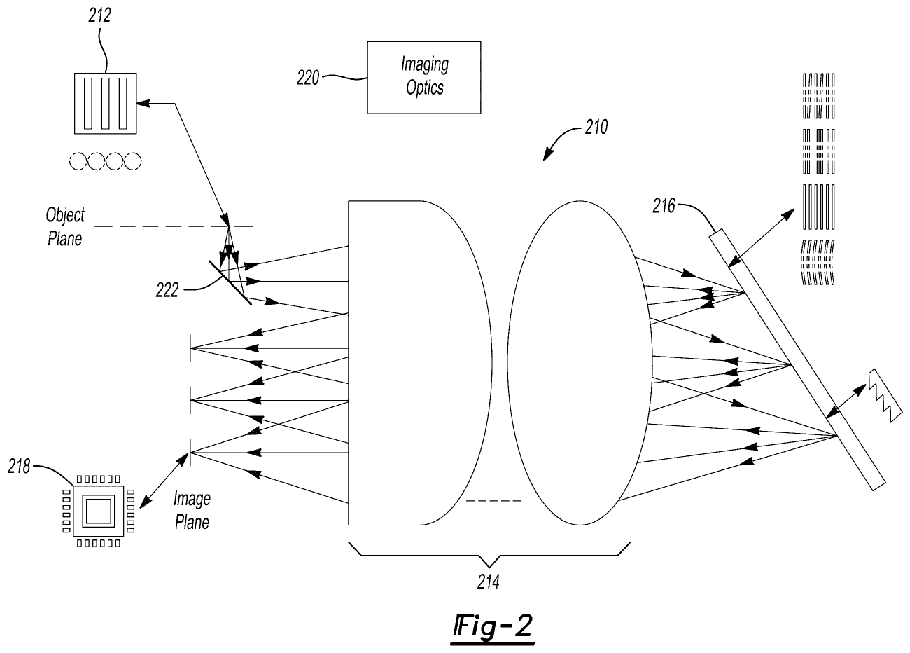

Referring to FIG. 2, a spectrometer 210 includes an entrance assembly 212, a lens assembly 214, a flat substrate reflection diffraction grating 216, a sensor array 218, imaging optics 220, and a folding mirror 222. FIG. 2 illustrates an alternative optical configuration in which the folding mirror 222 is positioned downstream of the entrance assembly 212 to redirect the incoming light and modify the geometric relationship between the entrance assembly 212 and the lens assembly 214. In this arrangement, the entrance assembly 212 defines the object plane, and the sensor array 218 defines the image plane, but the planes are located at positions different from those shown in FIG. 1.

The folding mirror 222 directs the input light along a compact optical path toward the lens assembly 214, which collimates the light and directs it to the diffraction grating 216. The diffraction grating 216 disperses and reflects the light back through the lens assembly 214 in a double-pass configuration, after which the dispersed wavelengths converge at distinct lateral positions along the sensor array 218.

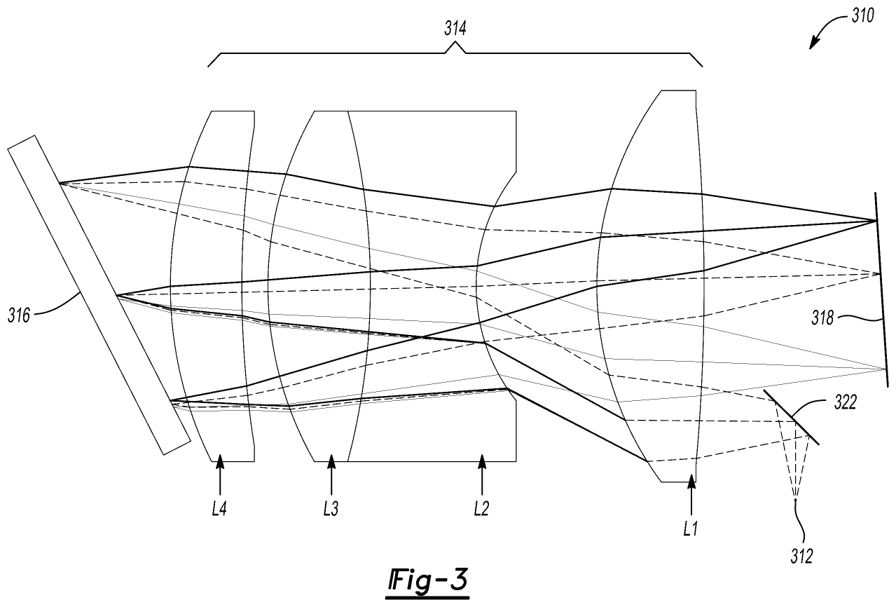

Referring to FIG. 3, a spectrometer 310 includes an entrance or input region 312, a lens system 314, a flat substrate reflection diffraction grating 316, and a sensor or output plane 318. FIG. 3 presents a representative ray-tracing simulation illustrating a top view of a double-pass optical configuration suitable for Raman spectroscopy. In this example, the diffraction grating 316 has a groove density of approximately 1200 grooves per millimeter, although other groove densities may be selected depending on the desired spectral resolution and wavelength coverage.

Input light enters the spectrometer 310 at the entrance region 312, which may receive light from a slit, fiber, or fiber array, as described with respect to FIG. 1. In the illustrated embodiment, the incoming light is incident from the lower right of the Figure and is directed toward the lens system 314 by a folding element 322, such as a flat mirror. The folding element 322 redirects the optical path to achieve a compact mechanical layout while maintaining the required object-plane alignment with the lens system 314.

The lens system 314 includes multiple lens groups, labeled L1 through L4, arranged to collimate the input light before it reaches the diffraction grating 316. Each lens group contributes to aberration correction, pupil management, and telecentricity control.

The diffraction grating 316 angularly disperses the incident light according to wavelength and reflects the dispersed light back toward the lens system 314. After reflection from the diffraction grating 316, the lens system 314 operates in a reverse pass, focusing the dispersed wavelengths onto the sensor plane 318. The ray tracing simulation in FIG. 3 shows multiple wavelength components, illustrated as distinct ray bundles, each refocused to a corresponding lateral position at the sensor plane 318. The double-pass architecture allows the same lens system 314 to provide collimation in the forward pass. The same lens system 314 also provides imaging in the return pass. This arrangement reduces system complexity. It also maintains high resolution and high throughput.

The sensor plane 318 may include a one-dimensional or two-dimensional detector array configured to record the dispersed spectrum or multiple spectra simultaneously. The illustrated focusing pattern demonstrates how different wavelength components converge to discrete locations along the sensor plane 318, forming the spectral output of spectrometer 310.

While example embodiments are described above, these embodiments are not intended to encompass all possible forms of the disclosed subject matter. The terminology used herein is intended to describe the disclosed features rather than to limit them, and various modifications may be made without departing from the scope of the present disclosure. Furthermore, the features described with respect to different embodiments may be combined or integrated in other embodiments unless expressly stated otherwise.

What is claimed is:

1. A spectrometer comprising:
an entrance aperture configured to receive light from a sample;
a lens system configured to collimate light from the entrance aperture;
a flat substrate reflection diffraction grating positioned to receive light from the lens system and to diffract and reflect the light back through the lens system; and
a sensor positioned to receive light from the flat substrate reflection diffraction grating after passing through the lens system, wherein the lens system is further configured to focus the light from the flat substrate reflection diffraction grating onto the sensor.

2. The spectrometer of claim 1, wherein the lens system comprises an assembly of lenses.

3. The spectrometer of claim 1, wherein the lens system comprises one or more refractive lenses, diffractive lenses including metalenses, or a combination of refractive and diffractive lenses.

4. The spectrometer of claim 1, wherein the entrance aperture comprises at least one of a slit, a slit array, an optical fiber array, or a combination thereof.

5. The spectrometer of claim 4 further comprising a plurality of selectable entrance apertures arranged in a vertical or horizontal array, and being selectable to provide (i) single-channel operation in which light from a chosen entrance aperture produces a spectrum recorded at a corresponding position on the sensor or (ii) multi-channel operation in which spectra from different entrance apertures are simultaneously recorded as laterally shifted, superimposed spectra on the sensor.

6. The spectrometer of claim 1 further comprising imaging optics configured to generate an image of an elongated source along the entrance aperture.

7. The spectrometer of claim 1, wherein the entrance aperture and the sensor are located in a same plane.

8. The spectrometer of claim 1, wherein the entrance aperture and the sensor are located in different planes.

9. The spectrometer of claim 1, wherein an entrance port is positioned in an object plane of the lens system and an exit port is positioned in an image plane of the lens system and wherein the entrance port and the exit port have a same orientation.

10. The spectrometer of claim 1, wherein an entrance port is positioned in an object plane of the lens system and an exit port is positioned in an image plane of the lens system and wherein the entrance port and the exit port have different orientations.

11. The spectrometer of claim 1, wherein an entrance port and an exit port are positioned a same working distance from the lens system.

12. The spectrometer of claim 1, wherein an entrance port and an exit port are positioned different working distances from the lens system.

13. The spectrometer of claim 1, wherein the flat substrate reflection diffraction grating comprises a flat reflective optical dispersing element.

14. The spectrometer of claim 1, wherein the flat substrate reflective diffraction grating comprises a metasurface grating or a grating with parallel or non-parallel grooves, equal or non-equal groove spacing, or curved or non-curved grooves.

15. The spectrometer of claim 1, wherein the flat substrate reflection diffraction grating has a groove density greater than 350 grooves per millimeter.

16. The spectrometer of claim 15, wherein the flat substrate reflection diffraction grating has a groove density greater than 900 grooves per millimeter.

17. The spectrometer of claim 1, wherein the lens system is configured such that a chief ray associated with each wavelength impinges on the sensor at a same angle.

18. The spectrometer of claim 1, wherein light received at the entrance aperture passes through the lens system to the flat substrate reflection diffraction grating and is reflected by the flat substrate reflection diffraction grating back through the lens system to the sensor.

19. The spectrometer according to claim 1, wherein the spectrometer is configured for use in optical emission spectroscopy or optical reflectometry.

20. The spectrometer according to claim 1, wherein the spectrometer is configured for use in optical coherence tomography or spectral-domain optical coherence tomography.
